(19) United States
(12) Patent Application Publication
(10) Pub. No.: US 2019/0042853 A1
(43) Pub. Date: Feb. 7, 2019

(54) System and Method of Determining Video Content

(71) Applicant: Facebook, Inc., Menlo Park, CA (US)

(72) Inventor: John Kerl, Washington, DC (US)

(21) Appl. No.: 15/668,968

(22) Filed: Aug. 4, 2017

(51) Int. Cl. G06K 9/00; G06Q 50/00; H04N 21/454

(52) U.S. Cl. CPC G06K 9/00744; G06K 9/00718; H04N 21/4542; G06Q 50/01; G06K 9/00765

(57) ABSTRACT

In one or more embodiments, one or more systems, methods, and/or processes may receive a first video from a network; compute first hash values of first frames of the first video; determine, from a data structure that stores second hash values of second frames of a second video based at least on spatial relationships among respective portions of the second hash values, a number of the second hash values that are within a distance of one or more of the first hash values; and determine that the first video includes at least a portion of the second video based at least on the number of the second hash values that are within the distance value of the one or more of the first hash values and based at least on a minimum of a number of frames of the first video and a number of frames of the second video.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g., wall posts, photo-sharing, video sharing, event organization, messaging, games, or advertisements) to facilitate social interaction between or among users. For example, the social-networking system may receive videos and photos from users, which may be shared among users of the social-networking system.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

### SUMMARY OF PARTICULAR EMBODIMENTS

In particular embodiments, one or more systems, methods, and/or processes may determine if a user-uploaded video (UUV) includes one or more portions of one or more videos that have been flagged. For example, the UUV may be received from a network. In particular embodiments, the one or more videos may have been flagged as including one or more nefarious and/or unlawful portions. For example, the one or more nefarious and/or unlawful portions may include child pornography, terrorist propaganda, images of terrorism, images of unlawful behavior, non-consensually distributed explicit images, etc. In particular embodiments, hash values of frames of the one or more videos that have been flagged may be stored in a database. For example, the database may be or include a computer system.

In particular embodiments, the one or more systems, methods, and/or processes may compute hash values of frames of the UUV. For example, determining if the UUV includes one or more portions of one or more videos that have been flagged may include comparing the hash values of frames of the UUV with the hash values of frames of the one or more videos that have been flagged. In particular embodiments, the one or more systems, methods, and/or processes may determine distances between at least a portion of the hash values of frames of the UUV and the hash values of frames of the one or more videos that have been flagged in determining if the UUV includes one or more portions of one or more videos that have been flagged. For example, a hash value of a frame of a video may be associated with a coordinate in a coordinate system. For instance, the coordinate system may be or include a N-dimensional Euclidean coordinate system.

In particular embodiments, a data structure may store hash values of a flagged video of the one or more videos that have been flagged based at least on spatial relationships among respective portions of the hash values of the flagged video. For example, the data structure may be or include a space partitioning data structure. For instance, the space partitioning data structure may be or include a k-dimensional tree. In particular embodiments, the data structure may be searchable by a multidimensional search key. For example, the multidimensional search key may be or include a vector. For instance, the vector may include all or some portions of a hash value. In particular embodiments, the data structure may be utilized in determining distances between at least a first portion of the hash values of frames of the UUV and the hash values of frames of the flagged video. In one example, a second portion of the hash values of frames of the UUV may be decimated. For instance, the second portion of the hash values of frames of the UUV may be decimated utilizing a decimation ratio. In another example, a third portion of the hash values of frames of the UUV that include duplicate hash values may be removed. For instance, the one or more systems, methods, and/or processes may determine the duplicate hash values, and in response to determining the duplicate hash values, the one or more systems, methods, and/or processes may remove the duplicate hash values from the hash values of frames of the UUV. In particular embodiments, determining duplicate hash values of a first hash value may include determining that the duplicate hash values match the first hash value. For example, determining that the duplicate hash values match the first hash value may include determining that the first hash value is within a distance of the duplicate hash values.

In particular embodiments, determining if the UUV includes one or more portions of one or more videos that have been flagged may include determining, from the data structure that stores the hash values of frames of the flagged video, a number of the hash values of frames of the flagged video that are within a distance of one or more of the hash values of frames of the UUV. For example, the one or more systems, methods, and/or processes may determine that the UUV includes at least a portion of the flagged video based at least on the number of the hash values of the frames of the flagged video that are within the distance value of the one or more of the hash values of frames of the UUV and based at least on a minimum of a number of frames of the UUV video and a number of frames of the flagged video. In one instance, if the UUV includes at least a portion of the flagged video, the UUV may be rejected. In another instance, if the UUV does not at least a portion of the flagged video, the UUV may be posted to a social networking system for viewing by users of the social networking system. In particular embodiments, rejecting the UUV may include informing one or more of the user (e.g., the user that uploaded the video) and an administrator, among others, that the UUV was rejected. For example, informing the one or more of the user and the administrator, among others, that the UUV was rejected may include providing a message to the one or more of the user and the administrator, among others. For instance, the message may be provided by one or more of an email, a web page, and a display, among others.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example network environment associated with a social-networking system, according to particular embodiments;

FIG. 2 illustrates an example method of determining if a first video includes one or more portions of a second video, according to particular embodiments;

FIG. 3 illustrates an example of a space partitioning data structure, according to particular embodiments; and

FIG. 4 illustrates an example computer system, according to particular embodiments.

### DESCRIPTION OF EXAMPLE EMBODIMENTS

In particular embodiments, one or more systems, methods, and/or processes may determine if a user-uploaded video (UUV) includes one or more portions of one or more videos that have been flagged. For example, the one or more videos may have been flagged as including one or more nefarious and/or unlawful portions. For instance, the one or more nefarious and/or unlawful portions may include child pornography (CP), terrorist propaganda, images of terrorism, images of unlawful behavior, non-consensually distributed explicit images, etc. In particular embodiments, hash values of frames of the one or more videos that have been flagged may be stored in a database. For example, the one or more systems, methods, and/or processes described herein may compare hash values of frames of a UUV with hash values of frames of the one or more videos that have been flagged may be stored in the database in determining if the UUV includes one or more portions of the one or more videos that have been flagged.

In particular embodiments, the one or more systems, methods, and/or processes may determine distances between at least a portion of the hash values of frames of the UUV and hash values of frames of the one or more videos that have been flagged. In one example, a hash value of a frame of a video may be associated with a coordinate in a coordinate system. For instance, the coordinate system may be or include a N-dimensional Euclidean coordinate system. In another example, a distance between two hash values may be or include an edit distance, and the edit distance may be determined between a hash value of a frame of a first video and a hash value of a frame of a second video, different from the first video. For instance, a Hamming distance may be determined between a hash value of a frame of a first video and a hash value of a frame of a second video, different from the first video.

In particular embodiments, a frame of a UUV may be determined to match a frame of a flagged video if a hash value of the frame of the UUV is within a distance of a hash value of the frame of the flagged video. For example, this type of match may be or include a “fuzzy match”, rather than an exact match. For instance, it may not be necessary for two frames to have exactly the same content in order for a video and/or image matching process or method to find and/or determine a match. In one or more embodiments, each of the two frames may include one or more slight variations of the other. In one example, one frame may be cropped from the other frame. In a second example, one frame may be larger than the other frame. In another example, one frame may include an extra element not included in the other frame.

In particular embodiments, a data structure may store hash values of frames of a flagged video, where the data structure may store the hash values based at least on spatial relationships among the second hash values, or at least among respective portions of the second hash values. For example, the data structure may be or include a space partitioning data structure. For instance, the space partitioning data structure may be or include a k-dimensional tree. In particular embodiments, the one or more systems, methods, and/or processes described herein may utilize the data structure in determining distances between at least a portion of the hash values of frames of the UUV and hashes of frames of the one or more videos that have been flagged.

In particular embodiments, one or more systems, methods, and/or processes may compute hash values of all frames of a UUV. In particular instances, a number of hash values of all the frames of the UUV may be reduced. For example, a number of hash values of all the frames of the UUV may be reduced based at least on a length of the UUV. For instance, a decimation ratio may be utilized in reducing the number of hash values of all the frames of the UUV. In particular embodiments, duplicate hash values may be eliminated. For example, hash values of all the frames of the UUV may be placed into a data structure to eliminate duplicate hash values. For instance, a first occurrence of a hash value in the data structure may be kept over any subsequent occurrence of the hash value.

In particular embodiments, one or more systems, methods, and/or processes may determine a number of frames in a flagged video are possible matches to frames in the UUV. For example, determining a number of frames in a flagged video are possible matches to frames in the UUV may include determining a number of hash values of frames of the flagged video that are within a confidence distance of a hash value of a frame of the UUV. For instance, the confidence distance may include a distance within the data structure that stores the hash values of the frames of the flagged video. In particular embodiments, the confidence distance may be 2304 (which is 48²), among others. For example, the confidence distance of 2304 may be utilized for hash values of some lengths. For instance, utilizing hash values of one hundred forty-four (144) bytes, the confidence distance may be 2304. In particular embodiments, the confidence distance may be the confidence distance may be fifteen (15), among others. For example, the confidence distance of fifteen (15) may be utilized for hash values of some lengths. For instance, utilizing hash values of sixty-four (64) bits, the confidence distance may be fifteen (15). In particular embodiments, a confidence distance may be chosen based on a distance measure. In one example, the distance measure may be or include an Euclidean distance measure between two hash values. For instance, the confidence distance may be 2304, among others, when utilizing an Euclidean distance measure. In another example, the distance measure may be or include an edit distance measure between two hash values. For instance, the confidence distance may be fifteen (15), among others, when utilizing an edit distance measure. In particular embodiments, determining the number of frames in the flagged video that are possible matches to frames in the UUV may be referred to as a frame-wise search. For example, various methods, processes, and/or systems may be utilized as, by, and/or included in the frame-wise search. For instance, the frame-wise search may include and/or utilize one or more of a space partitioning data structure (e.g., a k-dimensional tree), PhotoDNA (available from MICROSOFT, INC.), multidimensional vectors, edit distances, and one or more hashing methods and/or processes, among others.

In particular embodiments, determining if the flagged video matches the UUV may include computing Ω=a/min (b, c), where the numerator “a” is the number of hash values that matched between the UUV and the flagged video, and the denominator is the minimum of either “b” (the total number of frames in the UUV) or “c” (the total number of frames in the flagged video). If Ω is above a threshold, the UUV and the flagged video may be identified as a match or may be determined to be a possible match. For example, the threshold may be 0.9.

In particular embodiments, some hash values of frames of a flagged video may be removed in an ad hoc fashion. For example, hash values that correspond to frames that are mostly one color may be removed. For instance, the color may be black or be similar to black or may be white or be similar to white, as those may be sometimes used as a “screen-swipe” for transitioning scenes in a video. In some cases, too many of the frames of the UUV may be identified as matching too small a number of frames in a flagged video, in which case the UUV and the flagged video may be determined not to match. For instance, transition frames that are mostly one color with small glyphs (e.g., letters, numbers, etc.) or a small graphic in a corner of some frames may cause false positives.

In particular embodiments, one or more systems, methods, and/or processes may parallelized. For example, a data structure may be split into portions, and the portions of the data structure may be provided to each of multiple processors.

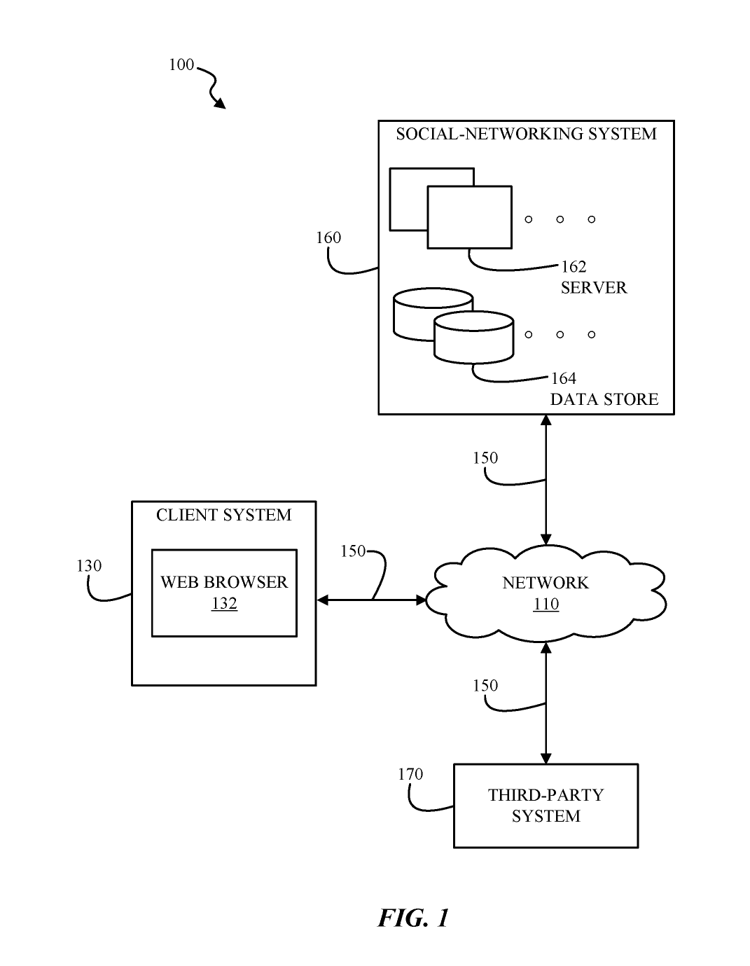

FIG. 1 illustrates an example network environment 100 associated with a social-networking system. As shown, network environment 100 may include a client system 130, a social-networking system 160, and a third-party system 170 connected to each other by a network 110. Although FIG. 1 illustrates a particular arrangement of client system 130, social-networking system 160, third-party system 170, and network 110, this disclosure contemplates any suitable arrangement of client system 130, social-networking system 160, third-party system 170, and network 110. As an example and not by way of limitation, two or more of client system 130, social-networking system 160, and third-party system 170 may be connected to each other directly, bypassing network 110. As another example, two or more of client system 130, social-networking system 160, and third-party system 170 may be physically or logically co-located with each other in whole or in part. Moreover, although FIG. 1 illustrates a particular number of client systems 130, social-networking systems 160, third-party systems 170, and networks 110, this disclosure contemplates any suitable number of client systems 130, social-networking systems 160, third-party systems 170, and networks 110. As an example and not by way of limitation, network environment 100 may include multiple client system 130, social-networking systems 160, third-party systems 170, and networks 110.

This disclosure contemplates any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Links 150 may connect client system 130, social-networking system 160, and third-party system 170 to communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 100. One or more first links 150 may differ in one or more respects from one or more second links 150.

In particular embodiments, client system 130 may be an electronic device including hardware, software, or embedded logic components or a combination of two or more such components and capable of carrying out the appropriate functionalities implemented or supported by client system 130. As an example and not by way of limitation, a client system 130 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 130. A client system 130 may enable a network user at client system 130 to access network 110. A client system 130 may enable its user to communicate with other users at other client systems 130.

In particular embodiments, client system 130 may include a web browser 132, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 130 may enter a Uniform Resource Locator (URL) or other address directing the web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to client system 130 one or more Hyper Text Markup Language (HTML) files responsive to the HTTP request. Client system 130 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 160 may be a network-addressable computing system that can host an online social network. Social-networking system 160 may generate, store, receive, and send social-networking data, such as, for example, user-profile data, concept-profile data, social-graph information, or other suitable data related to the online social network. Social-networking system 160 may be accessed by the other components of network environment 100 either directly or via network 110. As an example and not by way of limitation, client system 130 may access social-networking system 160 using a web browser 132, or a native application associated with social-networking system 160 (e.g., a mobile social-networking application, a messaging application, another suitable application, or any combination thereof) either directly or via network 110. In particular embodiments, social-networking system 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, social-networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a social-networking system 160, or a third-party system 170 to manage, retrieve, modify, add, or delete, the information stored in data store 164.

In particular embodiments, social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. Social-networking system 160 may provide users of the online social network the ability to communicate and interact with other users. In particular embodiments, users may join the online social network via social-networking system 160 and then add connections (e.g., relationships) to a number of other users of social-networking system 160 to whom they want to be connected. Herein, the term “friend” may refer to any other user of social-networking system 160 with whom a user has formed a connection, association, or relationship via social-networking system 160.

In particular embodiments, social-networking system 160 may provide users with the ability to take actions on various types of items or objects, supported by social-networking system 160. As an example and not by way of limitation, the items and objects may include groups or social networks to which users of social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 160 or by an external system of third-party system 170, which is separate from social-networking system 160 and coupled to social-networking system 160 via a network 110.

In particular embodiments, social-networking system 160 may be capable of linking a variety of entities. As an example and not by way of limitation, social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating social-networking system 160. In particular embodiments, however, social-networking system 160 and third-party systems 170 may operate in conjunction with each other to provide social-networking services to users of social-networking system 160 or third-party systems 170. In this sense, social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 160 also includes user-generated content objects, which may enhance a user's interactions with social-networking system 160. User-generated content may include anything a user can add, upload, send, or “post” to social-networking system 160. As an example and not by way of limitation, a user communicates posts to social-networking system 160 from a client system 130. Posts may include data such as status updates or other textual data, location information, photos, videos, links, music or other similar data or media. Content may also be added to social-networking system 160 by a third-party through a “communication channel,” such as a newsfeed or stream.

In particular embodiments, social-networking system 160 may include a variety of servers, sub-systems, programs, modules, logs, and data stores. In particular embodiments, social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 160 may also include suitable components such as network interfaces, security mechanisms, load balancers, failover servers, management-and-network-operations consoles, other suitable components, or any suitable combination thereof. In particular embodiments, social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 160 to one or more client systems 130 or one or more third-party system 170 via network 110. The web server may include a mail server or other messaging functionality for receiving and routing messages between social-networking system 160 and one or more client systems 130. An API-request server may allow a third-party system 170 to access information from social-networking system 160 by calling one or more APIs. An action logger may be used to receive communications from a web server about a user's actions on or off social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from client system 130 responsive to a request received from client system 130. Authorization servers may be used to enforce one or more privacy settings of the users of social-networking system 160. A privacy setting of a user determines how particular information associated with a user can be shared. The authorization server may allow users to opt in to or opt out of having their actions logged by social-networking system 160 or shared with other systems (e.g., third-party system 170), such as, for example, by setting appropriate privacy settings. Third-party-content-object stores may be used to store content objects received from third parties, such as a third-party system 170. Location stores may be used for storing location information received from client systems 130 associated with users. Advertisement-pricing modules may combine social information, the current time, location information, or other suitable information to provide relevant advertisements, in the form of notifications, to a user.

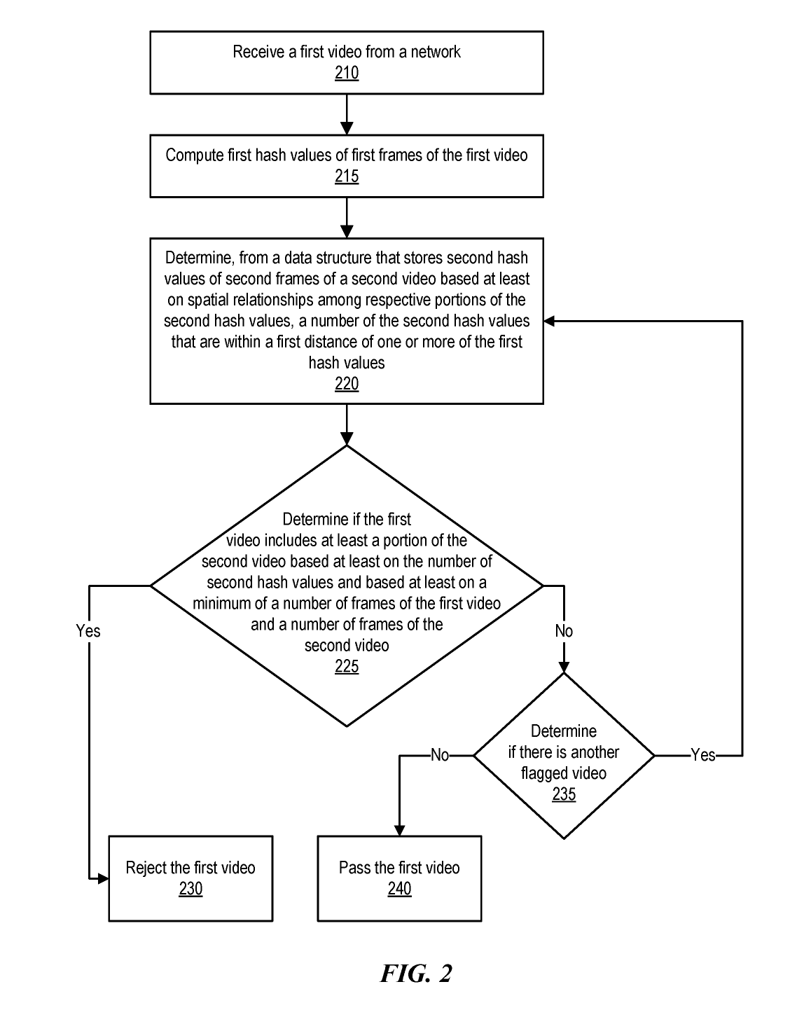

FIG. 2 illustrates an example method of determining if a first video includes one or more portions of a second video, according to particular embodiments. The method may begin at step 210, where a first video may be received from a network. For example, the first video may be received from network 110. In one instance, the first video may be received from client system 130 by network 110. In another instance, the first video may be or include a UUV.

At step 215, first hash values of first frames of the first video may be computed. In one or more embodiments, a hash value may be computed by utilizing a hashing method and/or process. For example, the hashing method and/or process may be or include one or more of a message digest (MD) (e.g., MD2, MD4, MD5, etc.), a RIPE-MD, a Davies-Meyer, a GOST Hash, a HAVAL, a N-HASH, a SHA (e.g., SHA-160, SHA-256, etc.), an Abreast Davies-Meyer, a SNEFRU, perpetual hashing (pHash), average hash (aHash), difference hash (dHash), Discrete Wavelet Transform (DWT) based image hash, hashing via Singular value Decomposition (SVD), and feature point based image hashing, among others. For instance, the hashing method and/or process may be or include a one-way hashing method and/or process.

At step 220, a number of second hash values, of second frames of a second video, that are within a first distance of one or more of the first hash values may be determined from a data structure that stores the second hash values based at least on spatial relationships among respective portions of the second hash values. In one example, the second hash values may be stored by data store 164. In another example, the data structure may be or include a space-partitioning data structure. For instance, the space-partitioning data structure may be or include a k-dimensional tree. In particular embodiments, the data structure may be searchable by a multidimensional search key. For example, the multidimensional search key may be or include a vector. For instance, the vector may include all or some portions of a hash value. In particular embodiments, the first distance may be or include a threshold. For example, determining the number of the second hash values, of the second frames of the second video, that are within the first distance of the one or more of the first hash values may include determining the number of the second hash values, of the second frames of the second video, that are within a proximity of one or more of the first hash values, based at least on the threshold. For instance, the threshold may be or include a confidence distance.

In particular embodiments, the confidence distance may be 2304 (which is 48²), among others. For example, the confidence distance of 2304 may be utilized for hash values of some lengths. For instance, utilizing hash values of one hundred forty-four (144) bytes, the confidence distance may be 2304. In particular embodiments, the confidence distance may be the confidence distance may be fifteen (15), among others. For example, the confidence distance of fifteen (15) may be utilized for hash values of some lengths. For instance, utilizing hash values of sixty-four (64) bits, the confidence distance may be fifteen (15). In particular embodiments, a confidence distance may be chosen based on a distance measure. In one example, the distance measure may be or include an Euclidean distance measure between two hash values. For instance, the confidence distance may be 2304, among others, when utilizing an Euclidean distance measure. In another example, the distance measure may be or include an edit distance measure between two hash values. For instance, the confidence distance may be fifteen (15), among others, when utilizing an edit distance measure.

In particular embodiments, a hash value of may include one hundred and forty-four (144) bytes. In one example, a vector may include one hundred and forty-four (144) dimensions. In another example, the vector may include sixteen (16) dimensions. In particular embodiments, the vector may include bytes one (1) through one hundred and forty-four (144) of the hash value. For example, the second hash values, of the second frames of the second video, may be stored in a k-dimensional tree, of dimension one hundred and forty-four (144), utilizing bytes one (1) through one hundred and forty-four (144) of the second hash values. In particular embodiments, the vector may include bytes sixty-four (64) through seventy-nine (79) of the one hundred and forty-four (144) bytes of the hash value. For example, the second hash values, of the second frames of the second video, may be stored in a k-dimensional tree, of dimension sixteen (16), utilizing bytes sixty-four (64) through seventy-nine (79) of the one hundred and forty-four (144) bytes of the second hash values.

In particular embodiments, the first distance may be or include a Euclidean distance. For example, a Euclidean distance between two N-dimensional vectors X={X₁, X₂, . . . , x_{N}} and Y={y₁, y₂, . . . , y_{N}} may be computed by

D=\sqrt{(x₁−y₁)²+(x₂−y₂)²+ . . . +(x_{N}−y_{N})²}

For instance, a vector associated with a hash value of the first hash values, of the first frames of the first video, may be X, and a hash value associated with a hash value of the second hash values, of the second frames of the second video, may be Y. In particular embodiments, Xᵢ may include a value of a byte of a first hash value, and yᵢ may include a value of a byte of a second hash value. In particular embodiments, determining if a hash value of a frame of the second video is within the first distance of a hash value of a frame of the first video may include representing the hash value of the frame of the second video as a vector Y, representing the hash value of the frame of the first video as a vector X, and determining if a Euclidean distance between X and Y is within the first distance. In particular embodiments, utilizing the data structure that stores the second hash values based at least on spatial relationships among respective portions of the second hash values may reduce a number of comparison and/or a number of computations. For example, one or more portions of the data structure may not be utilized in determining the number of the second hash values, of the second frames of the second video, that are within the first distance of the one or more of the first hash values. For instance, the data structure stores the second hash values based at least on spatial relationships, which may be utilized in determining that one or more of the second hash values may not be within the first distance without computing a distance between a hash value of a frame of the first video and a hash value of a frame of the second video.

In particular embodiments, a number of comparison and/or a number of distance computations may be reduced to M log₂ P, where M is a number of hash values of frames of the first video and P is a number of hash values of frames of the second video. For example, reducing the number of comparison and/or the number of computations may provide one or more speed advantages and/or improvements. For instance, without utilizing the data structure that stores the second hash values based at least on spatial relationships among respective portions of the second hash values, the number of comparison and/or the number of distance computations may be M·P.

In particular embodiments, a square of the distance may utilized. For example, utilizing the square of the distance may reduce a number of computations associated with one or more comparisons. For instance, the square of the distance may be computed by

$${D}^{2} = {\sum }_{i = 1}^{N} {( {x}_{i} - {y}_{i} )}^{2} .$$

At step 225, it may be determined if the first video includes at least a portion of the second video based at least on the number of the second hash values that are within the first distance value of the one or more of the first hash values and based at least on a minimum of a number of frames of the first video and a number of frames of the second video.

In particular embodiments, determining if the first video includes at least a portion of the second video based at least on the number of the second hash values that are within the first distance value of the one or more of the first hash values and based at least on a minimum of a number of frames of the first video and a number of frames of the second video may include computing

$$Ω = \frac{a}{min ( b , c )} .$$

For example, the numerator “a” may be the number of the second hash values that are within the first distance value of the one or more of the first hash values, and the denominator is a minimum of either “b”, a total number of first hash values, and “c”, a total number of second hash values. For instance, the number of the second hash values that are within the first distance value of the one or more of the first hash values may be considered as matching. In particular embodiments, determining if the first video includes at least a portion of the second video may include determining if Ω is at or above a threshold value. For example, the threshold value may be 0.9. It is noted that other threshold values may be utilized.

If the first video includes at least a portion of the second video, the first video may be rejected at step 230. If the first video does not include at least a portion of the second video, it may be determined if there is another flagged video, at step 235. If there is not another flagged video, the first video may be passed at step 240. If there is another flagged video, the method may proceed to step 220, where the other flagged video may be utilized as the second video, according to particular embodiments.

In particular embodiments, passing the first video may include posting the first video to a social-networking system. For example, the first video may be posted to an account, associated with a user, of social networking system 160. For instance, passing the first video may include allowing and/or permitting various users of social networking system 160 do download and/or view the first video. In particular embodiments, passing the first video may include repeating one or more portions of a method. For example, passing the first video may include repeating the method illustrated in FIG. 2 when additional flagged videos are available and/or are added. For instance, data store 164 may store flagged videos that may be utilized as the second video, and steps 220 and 225 may be repeated until the first video is rejected or until the first video passes when compared with each of the flagged videos. In particular embodiments, the second video and/or each of the flagged videos may include at least one of child pornography, terrorist propaganda, at least one image of child pornography, at least one image of terrorism, at least one image of unlawful behavior within a jurisdiction, and at least one non-consensual explicit image, among others.

In particular embodiments, the one or more of the first hash values utilized in step 225 may be a portion of all hash values of all frames of the first video. In one example, a portion of hash values of all frames of the first video may be decimated. For instance, decimating a portion of hash values of all frames of the first video may include utilizing a decimation ratio. In another example, duplicate hash values may be removed. For instance, it may be determine that a first hash value of the first hash values matches one or more hash values of the first hash values, and in response to determining that the first hash value of the first hash value matches the one or more hash values of the first hash values, the one or more hash values of the first hash values, that are duplicates, may be removed from the first hash values. In particular embodiments, determining that the first hash value matches the one or more hash values of the first hash values may include determining that the first hash value is within a second distance of the one or more hash values of the first hash values.

In particular embodiments, rejecting the first video may include informing one or more of a user (e.g., the user that uploaded the first video) and an administrator, among others, that the first video was rejected. For example, informing the one or more of the user and the administrator, among others, that the UUV was rejected may include providing a message to the one or more of the user and the administrator, among others. For instance, the message may be provided by one or more of an email, a web page, and a display, among others.

In particular embodiments, the data structure that stores the second hash values based at least on spatial relationships among respective portions of the second hash values may store other information or no information. In one example, the data structure may store information associated with the second frames of the flagged video and/or other information associated with the flagged video. In another example, the data structure may include nodes, and the data structure may not store information by the nodes of the data structure. For instance, the data structure may store relevant information by how hash values are arranged and/or how the data structure is arranged. In particular embodiments, storing the second hash values based at least on spatial relationships among respective portions of the second hash values may include storing the second hash values by indexes of the data structure.

Although this disclosure describes and illustrates particular steps of the method of FIG. 2 as occurring in a particular order, this disclosure contemplates any suitable steps of the method of FIG. 2 occurring in any suitable order. Moreover, although this disclosure describes and illustrates an example method of determining if a first video includes one or more portions of a second video, including the particular steps of the method of FIG. 2, this disclosure contemplates any suitable method of determining if a first video includes one or more portions of a second video including any suitable steps, which may include all, some, or none of the steps of the method of FIG. 2, where appropriate. Furthermore, although this disclosure describes and illustrates particular components, devices, or systems carrying out particular steps of the method of FIG. 2, this disclosure contemplates any suitable combination of any suitable components, devices, or systems carrying out any suitable steps of the method of FIG. 2.

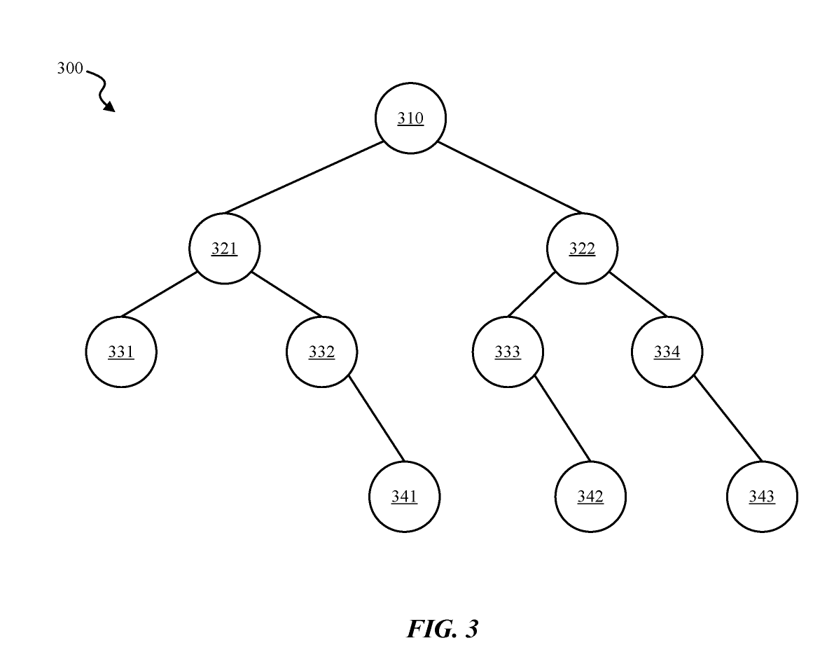

Turning now to FIG. 3, an example of a space partitioning data structure is illustrated, according to particular embodiments. As shown, an example of a space partitioning data structure, such as a k-dimensional tree 300, may include multiple nodes. In this example, k-dimensional tree 300 may include ten (10) nodes. It noted that any number of nodes may be utilized. In particular embodiments, the nodes of k-dimensional tree 300 may represent hash values of frames of a video. For example, the nodes of k-dimensional tree 300 may include the hash values of frames of the video. For instance, the video may be or include a flagged video.

In particular embodiments, ten frames of a video may be represented as nodes that may be spatially partitioned into the k-dimensional tree 300 based on portions of hash values of the ten frames. For example, the portions of the hash values of the ten frames may be or include sixteen (16) dimensions. For instance, the nodes may be spatially partitioned into the k-dimensional tree 300 based on respective sixteen (16) dimensional vectors associated with the hash values of the ten (10) frames.

In one example, a node 310 may be at a first level of k-dimensional tree 300. In a second example, nodes 321 and 322 may be at a second level of k-dimensional tree 300. For instance, nodes 321 and 322 may be stored by their respective first vector elements with respect to a first vector element of node 310. In a third example, nodes 331-334 may be at a third level of k-dimensional tree 300. In one instance, nodes 331 and 332 may be stored by their respective first vector elements with respect to the first vector element of node 310 and by their respective second vector elements with respect to a second vector element of node 321. In another instance, nodes 333 and 334 may be stored by their respective first vector elements with respect to the first vector element of node 310 and by their respective second vector elements with respect to a second vector element of node 322.

In another example, nodes 341-343 may be at a third level of k-dimensional tree 300. In one instance, node 341 may be stored by its respective first vector elements with respect to the first vector element of node 310, by its respective second vector elements with respect to the second vector element of node 321, and its respective third vector elements with respect to the third vector element of node 332. In a second instance, node 342 may be stored by its respective first vector elements with respect to the first vector element of node 310, by its respective second vector elements with respect to the second vector element of node 322, and its respective third vector elements with respect to the third vector element of node 333. In another instance, node 343 may be stored by its respective first vector elements with respect to the first vector element of node 310, by its respective second vector elements with respect to the second vector element of node 322, and its respective third vector elements with respect to the third vector element of node 334.

In particular embodiments, the example illustrated in FIG. 3, hash values of frames of a video may be partitioned into a k-dimensional tree level by level. For example, for each hash value, a set of k elements may be generated, which may be associated with k vector elements of the hash value. It is noted that although the example illustrated in FIG. 3 utilizes sixteen (16) as a specific value for k, k may be set to any suitable value. In particular embodiments, at each level i, given a specific node at level i, the sub-set of hash values belonging to this portion of the tree may be stored according to their respective i^{th} one of the k elements. If the tree has more than k levels, storing the hash values may repeat the cycle of k elements. For example, at level k+1, the first one of the k elements may be utilized again to store the hash values; at level k+2, the second one of the k elements may be utilized again to store the hash values; and so on, until all the hash values are partitioned into the k-dimensional tree. For instance, at each level i, the (i mod k)th element may be utilized to store the hash values, when appropriate.

In particular embodiments, conducting search through a k-dimensional tree may be faster than a straight comparison. For example, suppose that a hash value of a frame of a UUV is to be compared with the ten (10) hash values in the example of FIG. 3, which have already been stored in k-dimensional tree 300 as illustrated in FIG. 3. Without using k-dimensional tree 300, the hash value of the frame of the UUV would need to be compared with each and every one of the ten (10) hash values. This requires ten (10) comparisons (e.g., computing ten (10) proximity and/or distance measurements respectively between the hash value of the frame of the UUV and each of the ten (10) hash values). For example, utilizing k-dimensional tree 300, the hash value of the frame of the UUV may be compared with some of the ten (10) hash values, but not necessarily all of the ten (10) hash values. For instance, a comparison method and/or process may traverse k-dimensional tree 300 down recursively level by level, starting from its root node (e.g., node 310), and at each level, a sub-tree that does not need to be searched is not searched, which may reduce a number of comparisons and/or a number of computations.

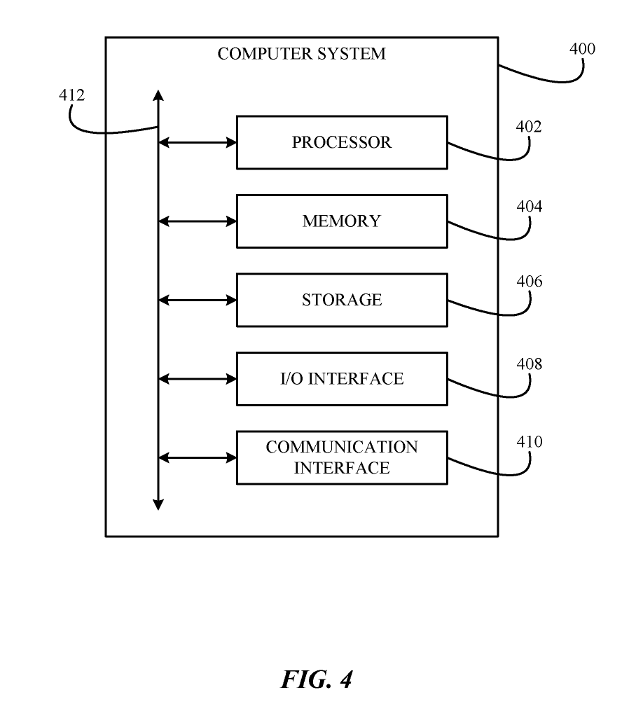

FIG. 4 illustrates an example computer system 400. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400. Herein, reference to a computer system may encompass a computing device, and vice versa, where appropriate. Moreover, reference to a computer system may encompass one or more computer systems, where appropriate.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In particular embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 402 includes hardware for executing instructions, such as those making up a computer program. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. This disclosure contemplates processor 402 including any suitable number of any suitable internal caches, where appropriate. As an example and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In particular embodiments, processor 402 may include one or more internal registers for data, instructions, or addresses. This disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In particular embodiments, memory 404 includes main memory for storing instructions for processor 402 to execute or data for processor 402 to operate on. As an example and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. In particular embodiments, memory 404 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 404 may include one or more memories 404, where appropriate. Although this disclosure describes and illustrates particular memory, this disclosure contemplates any suitable memory.

In particular embodiments, storage 406 includes mass storage for data or instructions. As an example and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In particular embodiments, storage 406 is non-volatile, solid-state memory. In particular embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In particular embodiments, I/O interface 408 includes hardware, software, or both, providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between computer system 400 and one or more other computer systems 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A system, comprising:
one or more processors; and
one or more storage media communicatively coupled to the one or more of the processors and include instructions operable when executed by the one or more processors to cause the system to:
receive a first video from a network;
compute first hash values of first frames of the first video;
determine, from a data structure that stores second hash values of second frames of a second video based at least on spatial relationships among respective portions of the second hash values, a number of the second hash values that are within a first distance of one or more of the first hash values; and
determine that the first video includes at least a portion of the second video based at least on the number of the second hash values that are within the first distance value of the one or more of the first hash values and based at least on a minimum of a number of frames of the first video and a number of frames of the second video.

2. The system of claim 1, wherein the data structure is a k-dimensional tree.

3. The system of claim 1, wherein the one or more storage media further include instructions operable when executed by the one or more processors further cause the system to:
decimate, utilizing a decimation ratio, a portion of the first frames of the first video.

4. The system of claim 1, wherein the one or more storage media further include instructions operable when executed by the one or more processors further cause the system to:
remove duplicate hash values from the first hash values.

5. The system of claim 4, wherein, to remove the duplicate hash values from the first hash values, the instructions further cause the system to:
determine that a first hash value of the first hash values matches one or more hash values of the first hash values; and
in response to determining that the first hash value of the first hash values matches the one or more hash values of the first hash values, remove the one or more hash values of the first hash values from the first hash values.

6. The system of claim 5, wherein, to determine that the first hash value of the first hash values matches the one or more hash values of the first hash values, the instructions further cause the system to:
determine that the first hash value is within a second distance of the one or more hash values of the first hash values.

7. The system of claim 1, wherein the second video includes at least one of child pornography, terrorist propaganda, at least one image of child pornography, at least one image of terrorism, at least one image of unlawful behavior within a jurisdiction, and at least one non-consensual explicit image.

8. A method, comprising:
receiving a first video from a network;
computing first hash values of first frames of the first video;
determining, from a data structure that stores second hash values of second frames of a second video based at least on spatial relationships among respective portions of the second hash values, a number the second hash values that are within a first distance of a plurality of the first hash values; and
determining that the first video includes at least a portion of the second video based at least on the number the second hash values that are within the first distance value of the plurality of the first hash values and at least on a minimum of a number of frames of the first video and a number of frames of the second video.

9. The method of claim 8, wherein the data structure is a k-dimensional tree.

10. The method of claim 8, further comprising:
decimating, utilizing a decimation ratio, a portion of the first frames of the first video.

11. The method of claim 8, further comprising:
removing duplicate hash values from the first hash values.

12. The method of claim 11, wherein the removing the duplicate hash values from the first hash values includes:
determining that a first hash value of the first hash values matches one or more hash values of the first hash values; and
in response to the determining that the first hash value of the first hash values matches the one or more hash values of the first hash values, removing the one or more hash values of the first hash values from the first hash values.

13. The method of claim 12, wherein the determining that the first hash value of the first hash values matches the one or more hash values of the first hash values includes determining that the first hash value is within a second distance of the one or more hash values of the first hash values.

14. The method of claim 8, wherein the second video includes at least one of child pornography, terrorist propaganda, at least one image of child pornography, at least one image of terrorism, at least one image of unlawful behavior within a jurisdiction, and at least one non-consensual explicit image.

15. One or more non-transitory computer-readable memory media that includes instructions executable by at least one processor of a system, wherein when the at least one processor executes the instructions, the instructions cause the system to:
receive a first video from a network;
compute first hash values of first frames of the first video;
determine, from a data structure that stores second hash values of second frames of a second video based at least on spatial relationships among respective portions of the second hash values, a number the second hash values that are within a first distance of a plurality of the first hash values; and
determine that the first video includes at least a portion of the second video based at least on the number the second hash values that are within the first distance value of the plurality of the first hash values and at least on a minimum of a number of frames of the first video and a number of frames of the second video.

16. The one or more non-transitory computer-readable memory media of claim 15, wherein the data structure is a k-dimensional tree.

17. The one or more non-transitory computer-readable memory media of claim 15, wherein the one or more non-transitory computer-readable memory media further include instructions operable when executed by the at least one processor further cause the system to:
decimate, utilizing a decimation ratio, a portion of the first frames of the first video.

18. The one or more non-transitory computer-readable memory media of claim 15, wherein the one or more non-transitory computer-readable memory media further include instructions operable when executed by the at least one processor further cause the system to:
remove duplicate hash values from the first hash values.

19. The one or more non-transitory computer-readable memory media of claim 18, wherein, to remove the duplicate hash values from the first hash values, the one or more non-transitory computer-readable memory media further include instructions operable when executed by the at least one processor further cause the system to:
determine that a first hash value of the first hash values matches one or more hash values of the first hash values; and
in response to determining that the first hash value of the first hash values matches the one or more hash values of the first hash values, remove the one or more hash values of the first hash values from the first hash values.

20. The one or more non-transitory computer-readable memory media of claim 15, wherein the second video includes at least one of child pornography, terrorist propaganda, at least one image of child pornography, at least one image of terrorism, at least one image of unlawful behavior within a jurisdiction, and at least one non-consensual explicit image.
